(19) United States
(12) Patent Application Publication
(10) Pub. No.: US 2026/0119416 A1
(43) Pub. Date: Apr. 30, 2026

(54) MEMORY EXPANSION DEVICE, AND DATA PROCESSING METHOD AND SYSTEM

(71) Applicant: SUZHOU METABRAIN INTELLIGENT TECHNOLOGY CO., LTD., Suzhou, Jiangsu (CN)

(72) Inventors: Long YUE, Suzhou, Jiangsu (CN); Yanwei WANG, Suzhou, Jiangsu (CN)

(21) Appl. No.: 19/125,235

(22) PCT Filed: Aug. 29, 2024
(86) PCT No.: PCT/CN2024/115334

§ 371 Date: Apr. 28, 2025

(30) Foreign Application Priority Data
Sep. 5, 2023 (CN) 202311133879.2

(51) Int. Cl. G06F 13/16; G06F 13/40

(52) U.S. Cl. CPC G06F 13/1663; G06F 13/4022

(57) ABSTRACT

The embodiments of the present disclosure disclose a memory expansion device, a data processing method and a system, and relates to the technical field of computers, which can improve the execution efficiency of a computing task by a host side after memory expansion. The memory expansion device, which comprises a protocol controller, configured to communicate with the host side and receive the target data request sent by the host side; an elastic computing manager, configured to switch the processing mode of the processing core according to the target data request; a processing core, configured to perform data processing operations on the target data associated with the target data request through different data processing paths according to different processing modes, and submit the processed target data to the memory or transmit the processed target data to the host side through the protocol controller; wherein, different data processing paths at least include: data processing paths corresponding to data processing operations on target data in an online processing mode and/or an offline processing mode.

### CROSS-REFERENCE TO RELATED APPLICATION

The present disclosure claims the priority of Chinese patent application filed in CNIPA on Sep. 5, 2023, with the application number of 202311133879.2 and the application name of “MEMORY EXPANSION DEVICE, AND DATA PROCESSING METHOD AND SYSTEM”, the entire contents of which are incorporated into the present disclosure by reference.

### FIELD

The present disclosure relates to the technical field of computers, in particular to a memory expansion device and a data processing method and system.

### BACKGROUND

With the increasing demand for memory capacity in computer systems, memory expansion technology is widely used in computer systems to meet their memory capacity requirements.

However, the host side needs to access the memory for many times when executing the computing task, but the access delay of the host side to the extended memory device is usually high, so that the execution efficiency of the computing task is reduced after the memory expansion.

### SUMMARY

The purpose of the embodiments of the present disclosure is to provide a memory expansion device, a data processing method and a system, which can improve the execution efficiency of a computing task by a host side after memory expansion.

In order to solve the above technical problems, in the first aspect, embodiments of the present disclosure provide a memory expansion device, which comprises a processing core, a protocol controller, an elastic computing manager and a memory, wherein the protocol controller is configured to connect to a host side, the processing core is connected to the protocol controller, the elastic computing manager and the memory respectively, and the protocol controller is connected to the elastic computing manager, wherein:
the protocol controller is configured to communicate with the host side and receive the target data request sent by the host side;
the elastic computing manager is configured to switch the processing mode of the processing core according to the target data request;
the processing core is configured to perform data processing operations on the target data associated with the target data request through different data processing paths according to different processing modes, and submit the processed target data to the memory or transmit the processed target data to the host side through the protocol controller;
different data processing paths at least include: data processing paths corresponding to data processing operations on target data in an online processing mode and/or an offline processing mode.

In the second aspect, the embodiments of the present disclosure also provide a data processing system, which includes a host side and a memory expansion device as in the first aspect, and the host side is connected to the memory expansion device.

In the third aspect, the embodiments of the present disclosure also provide a data processing method, which is applied to the memory expansion device of the first aspect, and the method comprises:
receiving, by the protocol controller, the target data request sent by the host side;
switching, by the elastic computing manager, the processing mode of the processing core according to the target data request;
performing, by the processing core, data processing operation on the target data associated with the target data request through the data processing path corresponding to the processing mode of the processing core, and submitting, by the processing core, the processed target data to the memory or transmitting the processed target data to the host side through the protocol controller;
wherein, the data processing paths at least comprise data processing paths corresponding to data processing operations performed on the target data in the online processing mode and/or the offline processing mode.

It can be seen from the above technical solution that the processing core is configured between the protocol controller and the memory in the memory expansion device, and the processing core is controlled by the elastic computing manager to perform data processing operations required by different computing tasks through different data processing paths, thus implementing a general memory expansion device supporting programmable inline computing functions, which can meet the computing requirements of different computing tasks. Therefore, part of the operations of the host side may be offloaded to the memory expansion device, and the memory access and data processing operations related to the calculation tasks are carried out inside the memory expansion device, so that a large number of high-delay memory accesses between the host side and the memory expansion device involved in the execution process of the calculation tasks by the host side are replaced by low-delay accesses inside the memory expansion device, thereby reducing the total delay of the execution of the calculation tasks by the host side and improving the execution efficiency of the calculation tasks by the host side.

### BRIEF DESCRIPTION OF THE DRAWINGS

In order to explain the embodiments of the present disclosure more clearly, the drawings needed in the embodiments will be briefly introduced below. Apparently, the drawings described below are only some embodiments of the present disclosure. For persons skilled in the art, other drawings can be obtained according to these drawings without expenditure of creative labor.

FIG. 1 is a schematic structural diagram of a memory expansion device provided by an embodiment of the present disclosure;

FIG. 2 is a schematic diagram of a data processing path provided by an embodiment of the present disclosure;

FIG. 3 is a schematic diagram of another data processing path provided by an embodiment of the present disclosure;

FIG. 4 is a schematic diagram of another data processing path provided by an embodiment of the present disclosure;

FIG. 5 is a schematic diagram of another data processing path provided by an embodiment of the present disclosure;

FIG. 6 is a schematic diagram of another data processing path provided by an embodiment of the present disclosure;

FIG. 7 is a schematic structural diagram of a processing engine provided by an embodiment of the present disclosure;

FIG. 8 is a schematic structural diagram of a processor provided by an embodiment of the present disclosure;

FIG. 9 is a schematic structural diagram of another memory expansion device provided by an embodiment of the present disclosure;

FIG. 10 is a schematic structural diagram of a data processing system provided by an embodiment of the present disclosure;

FIG. 11 is a schematic diagram of an electronic device provided by an embodiment of the present disclosure;

FIG. 12 is a schematic diagram of a non-transitory computer readable storage medium provided by an embodiment of the present disclosure.

### DETAILED DESCRIPTION

In the following, the technical solution in the embodiments of the present disclosure will be clearly and completely described with reference to the drawings in the embodiments of the present disclosure. Apparently, the described embodiments are only a part of the embodiments of the present disclosure, but not the whole embodiment. Based on the embodiments in the present disclosure, all other embodiments obtained by persons skilled in the art without expenditure of creative labor belong to the protection scope of the present disclosure.

The terms “including” and “having” in the specification and claims of the present disclosure and the above drawings, as well as any variations thereof, are intended to cover non-exclusive inclusion. For example, a process, method, system, product or equipment that includes a series of steps or units is not limited to the listed steps or units, but may include steps or units that are not listed.

At present, the following two ways are usually configured to expand the memory capacity of the host side performing computing tasks in a computer system.
1. Dual-Inline-Memory-Modules (DIMMs) with large capacity are adopted, and all DIMM slot channels on the host side are configured to improve the memory capacity;
2. The memory expansion is realized by using the high-speed interconnection interface on the host side, such as the Compute Express Link (CXL) interface and the Peripheral Component Interconnect Express (PCIE) interface.

Understandably, memory expansion will make the link of memory access at the host side longer, so that the access delay of the extended memory devices at the host side is usually higher, especially the memory devices extended by high-speed interconnection protocols such as CXL. Taking the memory devices extended by CXL protocol as an example, because CXL put forward the concept of exchange to support the pooling of memory resources, the access link of the host side to the memory devices extended by CXL protocol will be further lengthened, which will lead to higher access delay. For example, the access delay of the host side to the memory devices extended by CXL protocol will include fixed delay in the protocol, hardware path delay of switch devices, software delay and so on.

When the host side executes a calculation task, a typical calculation process includes four processes: loading instructions, loading data, Arithmetic and Logic Unit (ALU) calculating, and writing data, that is, a calculation process may require 3 to 4 memory accesses. Therefore, for a calculation task that needs N iterations of the above calculation process, all the calculation processes involved in the completion of the calculation task by the host side need 3N memory accesses. Assuming that the delay of each memory access is L, the total delay of memory access involved in the computing task executed at the host side is 3NL. Under the condition that the delay of ALU calculation at the host side is unchanged, if the host side expands its memory, L will increase, that is, the total delay of memory access involved in the execution of computing tasks at the host side will increase, resulting in an increase in the total delay of the computing task executed at the host side, thereby leading to a decrease in the execution efficiency of the computing task at the host side after memory expansion.

In view of the problems existing in the above related technologies, the present disclosure proposes a memory expansion device with programmable inline computing function, which can unload part of the operations of the host side to the memory expansion device, to reduce the number of times that the host side accesses the memory expansion device, thereby reducing the total time delay of executing the computing task by the host side and improving the execution efficiency of the computing task by the host side after memory expansion.

In the following, a memory expansion device provided by the embodiments of the present disclosure will be described in detail through some embodiments and application scenarios, with reference to the attached drawings.

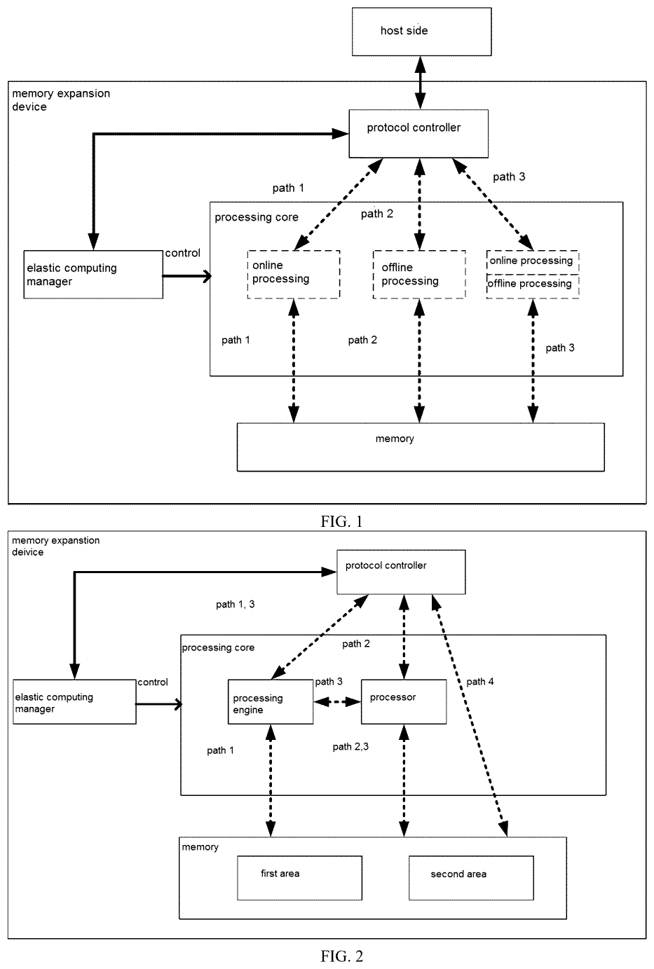

First, as shown in FIG. 1, it is a memory expansion device provided by an embodiment of the present disclosure. The memory expansion device includes a processing core, a protocol controller, an elastic computing manager and a memory, wherein the protocol controller is configured to connect a host side, the processing core is connected to the protocol controller, the elastic computing manager and the memory respectively, and the protocol controller is connected to the elastic computing manager, wherein:
the protocol controller is configured to communicate with the host side and receive a target data request sent by the host side;
the elastic computing manager is configured to switch a processing mode of the processing core according to the target data request;
the processing core is configured to perform data processing operations on target data associated with the target data request by different data processing paths according to different current processing modes of the processing core, and submit the processed target data to a memory or transmit the processed target data to the host side by the protocol controller.

The different data processing paths at least comprise data processing paths corresponding to data processing operations performed on the target data in an online processing mode and/or an offline processing mode; the target data request may include at least one of a read request and a write request associated with a computing task; the memory expansion device supports the programmable inline calculation function, and the user can configure the corresponding calculation flow for the processing core through the elastic computing manager in advance according to the calculation tasks required by the host side, so that the processing core can perform partial operations on data instead of the host side. For example, the host side can configure the elastic computing manager through the instruction bus of the protocol controller, and the configuration parameters include the calculation parameters required by the processing core to perform data processing operations. In the execution process, the elastic computing manager controls the processing mode of the processing core to control the participation state of the processing core in the computing task (that is, to control the processing core to execute data processing operations associated with the computing task with different data processing paths). Protocol controller (such as CXL protocol controller) includes a physical layer, a data link layer and a transaction layer. The physical layer mainly realizes the encoding and decoding of various data messages. The data link layer is an intermediate medium layer between the physical layer and the transaction layer, and is mainly responsible for providing a reliable mechanism for data exchange between the physical layer and the transaction layer. The transaction layer provides buses of three sub-protocols: input/output (IO), memory (MEM) and cache, and communicates directly with the processing core.

In this embodiment, the processing core is set between the protocol controller and the memory, and the elastic computing manager is configured to control the processing core to flexibly switch processing modes, to add programmable inline computing functions to the memory expansion device (that is, the elastic computing manager can adaptively change the processing modes of related functional modules configured to perform online processing or offline processing in the processing core according to the computing requirements of computing tasks, so that data passing through these related functional modules can enter different data processing paths with the change of processing modes. Each data processing path (path 1, path 2 and path 3) shown by a dotted line in FIG. 1 can be regarded as the target data entering the processing core after online processing by the processing core along path 1, and then it can leave the processing core and enter the host side or memory. Under the condition that only the offline processing related functional modules are in working mode, the target data that can be regarded as entering the processing core can leave the processing core and enter the host side or memory after being processed offline by the processing core along path 2; When the functional modules related to online processing and offline processing are both in working mode, it can be seen that the target data entering the processing core is processed online and offline by the processing core along path 3, and then leaves the processing core to enter the host side or memory.

Understandably, the elastic computing manager controls the processing core to perform data processing operations such as encryption and decryption, encoding and decoding, key value calculation, etc. through different data processing paths (i.e., adaptively online processing and/or offline processing), so that the requirements of different computing tasks can be met, and part of the operations performed by the host side are offloaded to the memory expansion device, to reduce the number of times that the host side accesses the memory expansion device.

For example, when executing a computing task, because the host side (such as Central Processing Unit (CPU)) usually adopts serial processing mode, and the traditional memory expansion device only stores data, the host side needs to perform memory reading, ALU calculation and memory writing operations on each data involved in the computing task respectively. And when a certain data needs to participate in different data processing operations in the same computing task, the host side needs to repeatedly read the data from the memory, so when the access delay between the host side and the memory expansion device is increased, the total delay of the host side executing the computing task will also be greatly increased.

Compared with the above-mentioned traditional memory expansion devices, by using the memory expansion device provided in the embodiments of the present disclosure, the host side can issue a read request, and during the process of the host side reading the memory, the processing core can perform data processing operations on the read request data stream that needs to be read by the host side. Thus, the host side can read the calculation result of the computing task (i.e., the read request data stream processed by the memory expansion device) from the memory expansion device at one time, thereby enabling the host side to know the calculation result of the computing task. The host side can also issue a write request to write the data involved in the computing task (i.e., the write request data stream) into the memory expansion device at one time. During the process of the host side writing the multiple data into the memory expansion device, the processing core performs data processing operations on the write request data stream and stores the obtained calculation result (i.e., the processed write request data stream) in the memory of the memory expansion device, thereby completing the memory write of the calculation result. The memory expansion device performs data processing in the process of memory reading and/or memory writing at the host side, so that the situation that the host side performs data reading and writing for many times or repeatedly during the execution of the calculation task can be avoided, thereby reducing the number of times that the host side accesses the memory expansion device, and further reducing the total execution delay of the calculation task.

It is understandable that the memory expansion device provided by the embodiments of this present disclosure, by offering programmable inline computing capabilities, enables the programmed processing cores to be controlled by the elastic computing manager to perform computations on data (such as write request data streams or read request data streams) during the process of memory access (such as memory write or memory read) at the host side through different data processing paths in an online processing manner and/or an offline processing manner. That is, the memory expansion device internally completes operations such as reading the data required for computing, performing data computations, and storing the computation results within the specified memory address range, thereby reducing the number of times the host side accesses the memory expansion device. As a result, a large number of high-delay memory accesses between the host and the memory expansion device are replaced by low-delay accesses within the memory expansion device (such as low-delay accesses between the processing cores and the memory within the memory expansion device), thereby reducing the total delay when the host side executes computing tasks

It can be seen from the above technical solution that the processing core is configured between the protocol controller and the memory in the memory expansion device, and the processing core is controlled by the elastic computing manager to perform data processing operations required by different computing tasks through different data processing paths, thus implementing a general memory expansion device supporting programmable inline computing functions, which can meet the computing requirements of different computing tasks. Therefore, part of the operations of the host side may be offloaded to the memory expansion device, and the memory access and data processing operations related to the calculation tasks are carried out inside the memory expansion device, so that a large number of high-delay memory accesses between the host side and the memory expansion device involved in the execution process of the calculation tasks by the host side are replaced by low-delay accesses inside the memory expansion device, thereby reducing the total delay of the execution of the calculation tasks by the host side and improving the execution efficiency of the calculation tasks by the host side.

In some embodiments, the processing core includes a processing engine and a processor, and the elastic computing manager is connected to the processing engine and the processor respectively, wherein:
the elastic computing manager is configured to switch the processing modes of the processing engine and the processor according to the target data request;
the processing engine is configured to select to perform data processing operation on the data passing through the processing engine in an online processing mode or not to perform data processing operation on the data passing through the processing engine according to the processing mode of the processing engine;
the processor is configured to select to perform data processing operation on the data passing through the processor in the offline processing mode or not to perform data processing operation on the data passing through the processor according to the processing mode of the processor.

In this embodiment, the processing engine can be an Intellectual Property core (IP core for short) based on a Field Programmable Gate Array (FPGA), and users can use the Register Transfer Level (RTL) circuit pre-configures the calculation flow for the processing engine, and configures the modes (such as straight-through mode and working mode) of the processing engine after starting through the elastic computing manager. The processing engine supports the calculation of the data stream currently received by itself with extremely low delay (that is, performs data processing operations on the data associated with the target data request in an online processing mode).

The processor can be a single-core processor or a multi-core processor, including but not limited to a hard-core processor or a soft-core processor. The user can pre-configure the calculation flow for the processor by programming methods such as C/C++, and configure the mode (such as bypass mode and working mode) of the processing engine after it is started through the elastic computing manager. The processor supports the calculation of data (i.e. data blocks) in its own cache by means of pipeline (i.e. performing data processing operations on data associated with the target data request in an offline way).

Understandably, compared with the processing engine, which can only process the currently received data stream (that is, the data that the host side needs to read and write), the processing object of the processor includes the whole memory area, so the processing method is more flexible. For example, the processor can cache the received data stream and the memory data needed to process the data stream, and then process the cached data, instead of just processing the received data stream.

In some embodiments, the processing modes of the processing engine include a straight-through mode and a working mode, and the processing modes of the processor include a bypass mode and a working mode.

In this embodiment, when the target data request submitted by the host side is a write request, if the processing engine is in the working mode, the processing engine then processes the write request data stream carried by the write request online according to its own configured related calculation flow, and submits the processed write request data stream to the processor; if the processing engine is in the straight-through mode, the processor directly submits the write request data stream carried by the write request to the processor. In the bypass mode, the processor will directly submit the data submitted by the processing engine to the memory for storage, while in the working mode, the data submitted by the processing engine will be processed offline and then submitted to the memory for storage; Similarly, if the target data request is a read request, if the processor is in working mode, it will offline process the read request data stream required for the read request submitted by the memory and submit it to the processing engine; if the processor is in bypass mode, it will directly submit the read request data stream submitted by the memory to the processing engine, and the processing engine will then select to process the read request data stream submitted by the processor online according to its processing mode, and transmits the processed read request data stream to the host side through the protocol controller, or transmits the read request data stream submitted by the processor directly to the host side through the protocol controller.

In order to enable the data entering the processing engine or processor to continue to enter the corresponding data processing path, the user (i.e. the host side) can configure the processing engine or processor into working mode or non-working mode (such as straight-through mode and bypass mode) through the elastic computing manager, or switch it into working mode or non-working mode after the processing engine or processor is started through the elastic computing manager, to turn on or off the processing function of the processing engine or processor for the data passing through it.

As a possible embodiment, the processing core is also configured to perform at least one of the following:
under the condition that the processing engine is in a working mode and the processor is in a bypass mode, performing data processing operation on the data passing through the processing core in the online processing mode through a first data processing path;
under the condition that the processing engine is in a straight-through mode and the processor is in a working mode, performing data processing operation on the data passing through the processing core in an offline processing mode through a second data processing path;
under the condition that the processing engine is in the working mode and the processor is in the working mode, performing data processing operation on the data passing through the processing core in an online processing mode and an offline processing mode through a third data processing path;
under the condition that the processing engine is in the straight-through mode and the processor is in the bypass mode, not performing data processing operation on the data passing through the processing core through a fourth data processing path.

In this embodiment, as shown in FIG. 2, the processing core can process the read request data stream and/or the write request data stream (i.e., target data) associated with the computing task independently or in combination through the following four data processing paths, so that the memory expansion device provided by the embodiments of the present disclosure can be applied to various computing tasks.
1. Implement a first data processing path (i.e., path 1) only processed by the processing engine.

The processor in the first data processing path is in bypass mode. At this time, the path can be regarded as that the target data directly enters the protocol controller or memory after being processed by the processing engine, and the processor is only configured to transmit the data received by itself.

In the concrete implementation, the processor is configured or switched to bypass mode, and does not process the data associated with the target data request received by itself, while the processing engine is configured or switched to work mode, which is configured to online process the data associated with the target data request received by itself according to the pre-configured calculation flow of the processing engine, that is, the processing core processes the target data entering the processing core through the first data processing path at this time.

The protocol controller is connected to the elastic computing manager through the instruction bus and is connected to the processing core through the data bus. According to the actual computing task requirements, the elastic computing manager can control the processor and processing engine to switch processing modes through the control status register (CSR) and interrupt controller connected to its own instruction bus. The host side can also send data streams carrying control parameters to the processor and processing engine through the protocol controller to control the processor and processing engine to switch processing modes, thereby changing the data processing path of the processing core.
2. Implement a second data processing path (i.e. path 2) only processed by the processor.

The processing engine in this second data processing path is in the straight-through mode, and will not perform data processing operations, resulting in additional delay. At this time, this path can be regarded as the target data directly entering the protocol controller or memory after being processed by the processor, and the processing engine is only configured to transmit the data received by itself.

In concrete implementation, the processing engine is configured or switched to the straight-through mode, and does not process the data associated with the target data request received by itself, while the processor is configured or switched to the working mode, which is configured to offline process the data associated with the target data request received by itself according to the pre-configured calculation flow of the processor, that is, the processing core processes the target data entering the processing core through the second data processing path at this time.
3. Implement a third data processing path (i.e., path 3) by mixed processing.

Both the processing engine and the processor in the third data processing path are in working mode, at this time, the path can be regarded as the target data after processing by the processor and processing engine respectively, and then enter the protocol controller or memory.

In concrete implementation, the processing engine is configured or switched to work mode for online processing of the data associated with the target data request received by itself according to the pre-configured calculation flow of the processing engine, and the processor is configured or switched to work mode for offline processing of the data associated with the target data request received by itself according to the pre-configured calculation flow of the processor, that is, the processing core processes the target data entering the processing core through the third data processing path at this time.
4. A fourth data processing path (i.e., path 4) where processing is not performed.

Both the processing engine and the processor in the fourth data processing path are in non-working mode, at this time, the path can be regarded as the target data is directly transmitted between the protocol controller and the memory.

In concrete implementation, both the processing engine and the controller are configured or switched to the non-working mode and do not process the data associated with the target data request received by themselves, that is, the protocol controller directly reads and writes data to the memory through the fourth data processing path.

As a possible implementation, the processing engine includes a write request data stream processing unit and a read request data stream processing unit, wherein:
the elastic computing manager is configured to select to switch at least one of the write request data stream processing unit and the read request data stream processing unit to the working mode to make the processing engine in the working mode, or select to switch both the write request data stream processing unit and the read request data stream processing unit to the straight-through mode to make the processing engine in the straight-through mode.

It can be understood that the processing core can flexibly select any one of the paths 1-4 as the path for processing the write request data stream, the read request data stream, or the read request data stream and the write request data stream based on the mode switching of the write request data stream processing unit and the read request data stream processing unit. For example, the processing core can flexibly select at least one of the paths 1-4 to complete the processing of the read and write request data stream based on the mode switching of the write request data stream processing unit.

Specifically, the target data includes at least one of a write request data stream and a read request data stream, wherein:
the write request data stream processing unit is configured to perform data processing operation on the write request data stream in the first data processing path or the third data processing path in the online processing mode when the write request data stream processing unit is in the working mode, and not to perform data processing operation on the write request data stream in the second data processing path or the fourth data processing path when the write request data stream processing unit is in the straight-through mode;
the read request data stream processing unit is configured to perform data processing operations on the read request data stream in the first data processing path or the third data processing path in the online processing mode when the read request data stream processing unit is in the working mode, and not to perform data processing operations on the read request data stream in the second data processing path or the fourth data processing path when the read request data stream processing unit is in the straight-through mode.

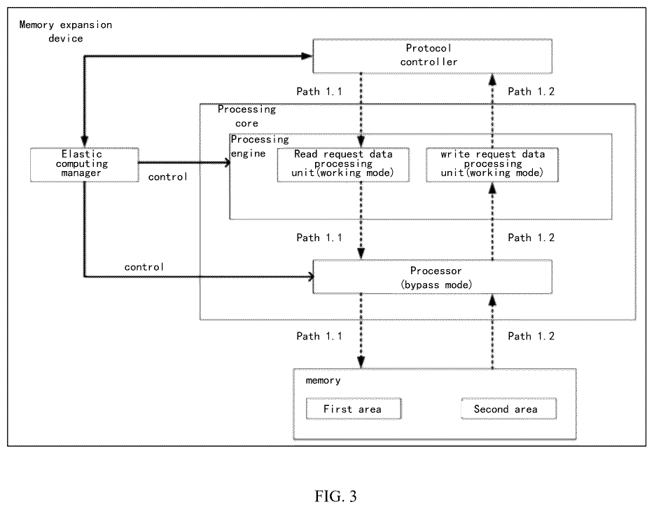

As shown in FIG. 3, when applied to the processing of write request data stream, the above-mentioned path 1 can be regarded as path 1.1, which is configured to realize the processing engine-only processing of write request data stream. At this time, the processing engine is in working mode, which means that the write request data stream processing unit is at least in working mode. When applied to the processing of read request data stream, the above-mentioned path 1 can be regarded as path 1.2, which is configured to realize the processing engine-only processing of read request data stream. At this time, the processing engine is in the working mode, which means that the read request data stream processing unit is at least in the working mode. When applied to the processing of the read and write request data stream, the above path 1 can be regarded as a combination of paths 1.1 and 1.2, which is configured to realize the processing engine-only processing of the read and write request data stream. At this time, the processing engine is in the working mode, which means that both the read request data stream processing unit and the write request data stream processing unit are in the working mode.

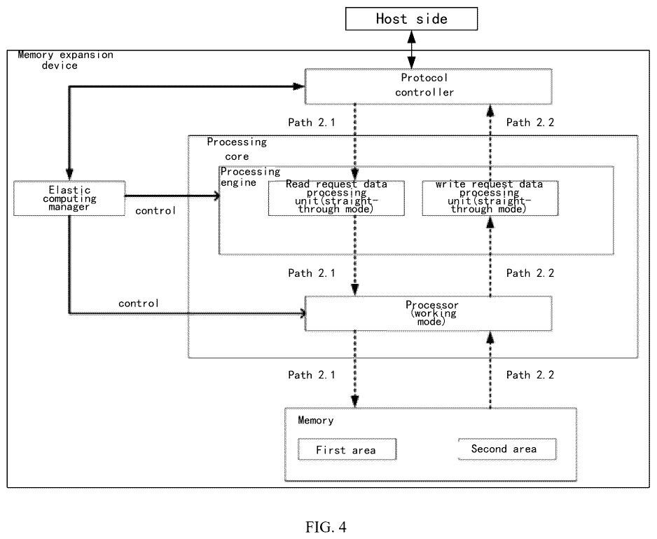

As shown in FIG. 4, when applied to the processing of write request data stream, the above-mentioned path 2 can be regarded as path 2.1, which is configured to realize the processor-only processing of write request data stream. At this time, the processing engine is in the straight-through mode, which means that the write request data stream processing unit is at least in the straight-through mode. When applied to the processing of read request data stream, the above-mentioned path 2 can be regarded as path 2.2, which is configured to realize the processor-only processing of read request data stream. At this time, the processing engine is in the straight-through mode, which means that the read request data stream processing unit is at least in the straight-through mode. When applied to the processing of the read and write request data stream, the above path 2 can be regarded as the combination of paths 2.1 and 2.2, which is configured to realize the processor-only processing of the read and write request data stream. At this time, the processing engine is in the straight-through mode, which means that both the read and write request data stream processing units are in the straight-through mode.

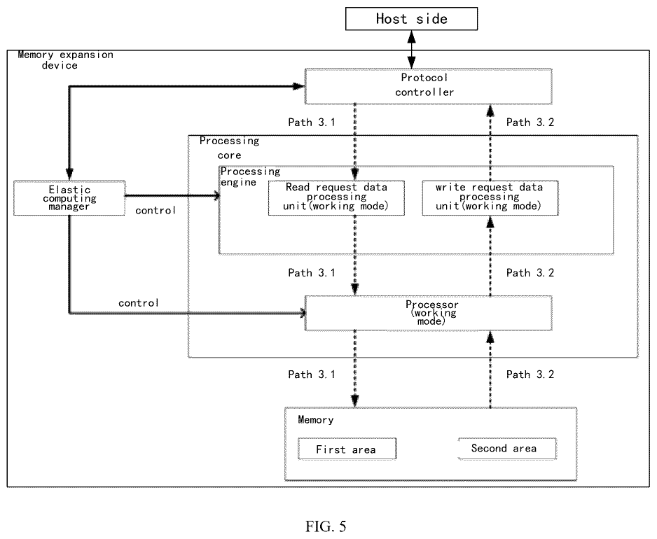

As shown in FIG. 5, when applied to the processing of write request data stream, the above path 3 can be regarded as path 3.1, which is configured to realize the mixed processing of write request data stream. At this time, the processing engine is in working mode, which means that the write request data stream processing unit is at least in working mode. When applied to the processing of read request data stream, the above path 3 can be regarded as path 3.2, which is configured to realize the mixed processing of read request data stream. At this time, the processing engine is in working mode, which means that the read request data stream processing unit is at least in working mode. When applied to the processing of read and write request data streams, the above path 3 can be regarded as a combination of paths 3.1 and 3.2, which is configured to realize the processor-only processing of read and write request data streams. At this time, the processing engine is in working mode, which means that both the read request data stream processing unit and the write request data stream processing unit are in working mode.

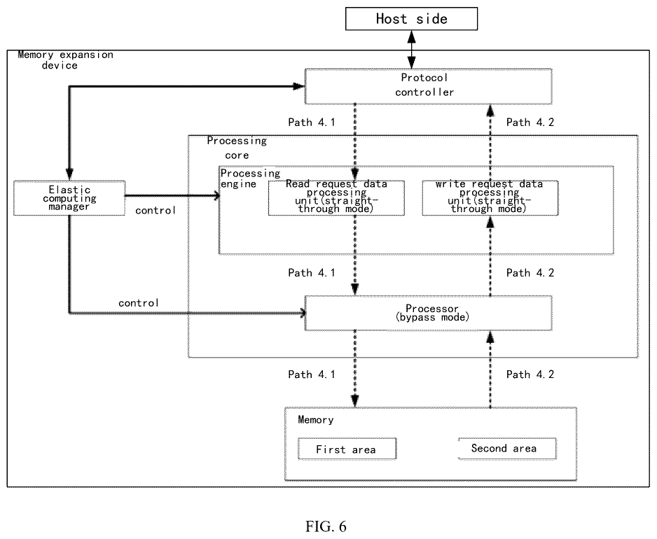

As shown in FIG. 6, the above-mentioned path 4 can be regarded as path 4.1 when applied to the processing of write request data stream, that is, the processing core does not process the write request data stream, that is, the processing engine is in the straight-through mode, that is, the write request data stream processing unit is at least in the straight-through mode, and that is, path 4 can be regarded as path 4.2 when applied to the processing of read request data stream, that is, the processing core does not process the read request data stream. At this time, the processing engine is in the straight-through mode, which means that the read request data stream processing unit is at least in the straight-through mode. When applied to the processing of read-write request data stream, the above path 4 can be regarded as the combination of paths 4.1 and 4.2, which means that the processing core does not process read-write request data stream, and the processing engine is in the straight-through mode, which means that both the read request data stream processing unit and the write request data stream processing unit are in the straight-through mode.

It can be understood that separate processing units are set for the write request data stream and the read request data stream to perform data processing operations, so that the processing engine can process the write request data stream and the read request data stream in parallel; And users can flexibly select a write request data stream processing unit and/or a read request data stream processing unit according to actual needs to build a processing engine, so that the built processing engine correspondingly supports the processing function of the write request data stream and/or the read request data stream, thereby improving the flexibility of the processing engine; It also enables users to flexibly decompose the configuration of the calculation flow into the configuration of the calculation flow for the read request data stream (that is, the configuration of the processing unit for the read request data stream) and/or the configuration of the calculation flow for the write request data stream (that is, the configuration of the processing unit for the write request data stream) when configuring the calculation flow for the processing engine, so that the development complexity can be reduced and the degree of freedom of the algorithm can be improved.

It can be understood that when a user configures a computing flow for a processing engine including a write request data stream processing unit and a read request data stream processing unit, the processing engine can be configured to process only the write request data stream, or only the read request data stream, or both the read and write request data streams according to the execution logic of the whole computing task or the execution logic of some operations unloaded to the memory expansion device.

For example, the user can only configure the calculation flow for the write request data stream processing unit or the read request data stream processing unit to perform data processing operations, while the processing unit without the calculation flow (i.e., the write request data stream processing unit or the read request data stream processing unit) will only be configured to transmit the data received by itself, The user or the protocol controller can also select to configure or switch the processing unit (i.e. write request data stream processing unit or read request data stream processing unit) to work mode or straight-through mode, to turn on or off the processing function of the corresponding processing unit (i.e. write request data stream processing unit or read request data stream processing unit) for the data it receives.

As a possible implementation, the processing engine is also configured to switch its own processing mode according to the first parameter in the target data the processing engine receives.

In this embodiment, the host side or the protocol controller can flexibly switch the processing engine to the straight-through mode or the working mode by embedding the control state parameter (i.e. the first parameter) in the data stream submitted to the processing engine, to meet the actual needs of the computing task.

As a possible implementation, the processing engine is also configured to add a second parameter to the target data received by the processing engine and send the target data to the processor;

The processor is also configured to switching its own processing mode according to the second parameter in the target data the processor receives.

In this embodiment, the host side, the protocol controller or the processing engine can flexibly switch the processor to the straight-through mode or the working mode by embedding the control state parameter (i.e. the second parameter) in the data stream submitted to the processor, to meet the actual needs of the computing task.

In one embodiment, as shown in FIG. 2, the memory includes a first area and a second area. The first area is configured to store data that has not been processed by the processing core, and the second area is configured to store data that has been processed by the processing core.

In this embodiment, as an ordinary memory area, the first memory area will not be modified by the processing core for memory expansion. In some embodiments, the first memory can be directly connected to the protocol controller. The second area serves as the buffer of the processing core, which will store the data processed by the processing engine (such as the write request data stream processing unit) and will also be modified when the multi-core processor executes the calculation process. The modified data can be processed by the read data stream processing unit or the processor before returning to the host side.

As a possible embodiment, the processor is respectively connected to the first area and the second area, wherein:
the processor is also configured to perform data processing operation on the write request data stream submitted by the host side through the protocol controller in an offline processing mode, submit the processed write request data to the second area, and perform data processing operation on the read request data stream submitted by the first area and/or the second area in an offline processing mode, and transmit the processed read request data stream to the host side through the protocol controller.

In this embodiment, when the processor processes the data associated with the target request, it can quickly read the data required for data processing from the first area or the second area according to the pre-configured calculation flow, and then perform data processing operation on the data associated with the target request according to the read data, thereby further improving the flexibility of data processing.

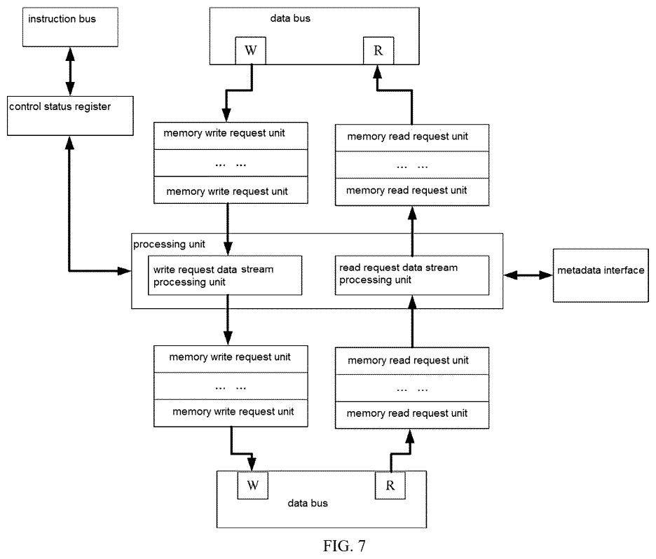

As a possible implementation, as shown in FIG. 7, the processing engine includes a write request data stream processing unit, and the processing engine also includes a metadata interface, wherein the write request data stream processing unit is connected to the metadata interface and the second area respectively, and the metadata interface is connected to the first area, wherein:
the write request data stream processing unit is also configured to directly submit the write request data stream submitted by the host side through the protocol controller to the first area through the metadata interface, and perform data processing operation on the write request data stream and submit the processed write request data stream to the second area.

In this embodiment, the write request data stream processing unit divides the write request data stream submitted by the host side into two paths to transmit in the device. One path is that the write request data stream processing unit directly transmits the write request data stream it receives through the metadata interface to the first area, which is configured to store the original data (i.e. metadata) written by the host side, thus providing the traditional memory expansion function. Another path is that the write request data stream processing unit directly transmits the write request data stream it receives through the metadata interface to the first area, which is configured to store the data (i.e. dynamic data) processed by the processing core, thus providing a buffer for processing cores such as processing engines and processors to perform data processing operations, and allowing the host side to read the processed data.

In some embodiments, the write request data stream processing unit can be connected to the second area through the processor, and the write request data stream processing unit can submit its processed or unprocessed write request data stream to the processor for processing, and then the processor submits the processed write request data stream to the second area for storage, thus improving the flexibility of the processing mode of the processing core for the write request data stream.

As a possible implementation, as shown in FIG. 7, the processing engine includes a read request data stream processing unit, and the processing engine also includes a metadata interface, wherein the read request data stream processing unit is connected to the metadata interface and the second area respectively, and the metadata interface is connected to the first area, wherein:
the elastic computing manager is further configured to control the read request data stream processing unit to perform a first read operation when the target data request sent by the host side comprises a first read request, receive the read request data stream submitted by the first area through the metadata interface, and directly transmit the received read request data stream to the host side through the protocol controller;
the elastic computing manager is further configured to control the read request data stream processing unit to perform a second read operation when the target data request sent by the host side comprises a second read request, perform data processing operation on the read request data stream submitted by the first area or the second area, and transmit the processed read request data stream to the host side through the protocol controller, or transmit the read request data stream submitted by the second area to the host side through the protocol controller.

In this embodiment, the read request sent by the host side can include a metadata read request (i.e. a first read request) and a processed data read request (i.e. a second read request). When the host side sends the first read request, the elastic computing manager controls the read request data stream processing unit to submit the corresponding read request data stream submitted by the first area through the metadata interface to the protocol controller for transmitting, so that the host side can read the data that has not been processed by the processing core (such as the original data related to the computing task written by the host side). When the host side sends the second reading request, the elastic computing manager controls the reading request data stream processing unit to receive the corresponding reading request data stream submitted by the first area or the second area, processes the corresponding reading request data stream and submits it to the protocol controller for transmitting, or according to the actual configuration of the user, the elastic computing manager can also control the read request data stream processing unit not to process the corresponding read request data stream submitted by the second area, and directly transmit it, so that the host side can read the data stored in the second area and processed by the processing core (that is, the calculation result).

It should be noted that the data transmitting operation of the metadata interface can be performed in parallel with the operations performed by the read request data stream processing unit and the write request data stream processing unit in the processing engine.

In some embodiments, as shown in FIG. 7, the processing engine further includes a control status register, and the control status register is respectively connected to the read request data stream processing unit and the elastic computing manager, wherein:
the elastic computing manager is also configured to control the read request data stream processing unit to execute the first read operation or the second read operation through the control status register.

In this embodiment, the elastic computing manager can control the reading mode of the read request data stream processing unit through CSR, and the CSR is connected to the elastic computing manager through an instruction bus, and correspondingly controls the read request data stream processing unit to perform the first reading operation or the second reading operation according to the first request or the second request sent by the host side.

The user can also pre-configure the read operation required by the read request data stream processing unit in CSR, such as only performing the first read operation, or only performing the second read operation, or performing the first read operation and the second read operation. When CSR receives the read request sent by the host side, it will automatically control the read request data stream processing unit to perform memory reading and/or data processing with the pre-configured read operation.

In some embodiments, the processing engine further includes a write request data stream processing unit, and the control status register is connected to the write request data stream processing unit, wherein:
the control state register is also configured to sett or record the states or parameters of the write request data stream processing unit and the read request data stream processing unit.

In this embodiment, the control status register can include all the control registers and status registers inside the processing engine, to set or record the status or parameters of the write request data stream processing unit and the read request data stream processing unit, such as the queue status of the memory read-write request unit in the buffer of the processing engine (the buffer is configured to buffer the write request data or read request data to be processed or sent by the processing engine in the form of units), the status and parameters of the processing core in the write data stream processing unit, and the status and parameters of the processing core in the read data stream processing unit. It can be understood that the protocol controller can switch the processing engine to the working mode or the straight-through mode by controlling CSR.

As a possible implementation, the write request data stream processing unit includes a plurality of downstream processing cores; The plurality of downstream processing cores are configured to perform data processing operations on the write request data stream in the data processing path where the write request data stream processing unit is located in parallel under the condition that the write request data stream processing unit is in the working mode.

In this embodiment, the write request data stream processing unit may include one or a plurality of downstream processing cores, and the plurality of downstream processing cores may be executed in parallel to improve processing efficiency. As shown in FIG. 7, each downstream processing core is connected to the data bus through a buffer, and the write request data stream submitted by the host side through the protocol controller will enter the corresponding buffer through the data bus, and then the buffer will enter the one or the plurality of downstream processing cores in a first-in-first-out order.

Specifically, the write request data stream will be submitted to the buffer in the form of units (that is, in the form of memory write request units), and the downstream processing core will process each memory write request unit in the buffer in turn according to the calculation flow. Each memory write request unit will enter the buffer after being processed, and then be submitted to the memory for storage or to the processor for further processing from the buffer in turn through the data bus.

As a possible implementation, the read request data stream processing unit includes a plurality of upstream processing cores; The plurality of upstream processing cores are configured to perform data processing operations on the read request data stream in the data processing path where the read request data stream processing unit is located in parallel under the condition that the read request data stream processing unit is in the working mode.

In this embodiment, as shown in FIG. 7, the read request data stream processing unit may include one or a plurality of upstream processing cores, and the plurality of upstream processing cores can be executed in parallel to improve processing efficiency. The write request data stream submitted by the memory or the processor will enter the buffer through the data bus, and then enter the one or the plurality of upstream processing cores in turn from the buffer.

Specifically, the read request data stream will be submitted to the buffer of the upstream processing core in the form of units (that is, in the form of memory write request units), and the upstream processing core will process each memory write request unit in its own buffer in turn according to the calculation flow. After each memory write request unit is processed, it will enter the buffer, and then it will be submitted to the protocol manager through the data bus for transmitting.

It should be noted that the upstream processing core is connected to the data bus through an upstream port, and the downstream processing core is connected to the data bus through a downstream port. Both the upstream port and the downstream port contain an IO transaction bus and a MEM transaction bus, and both buses can also support the burst mode.

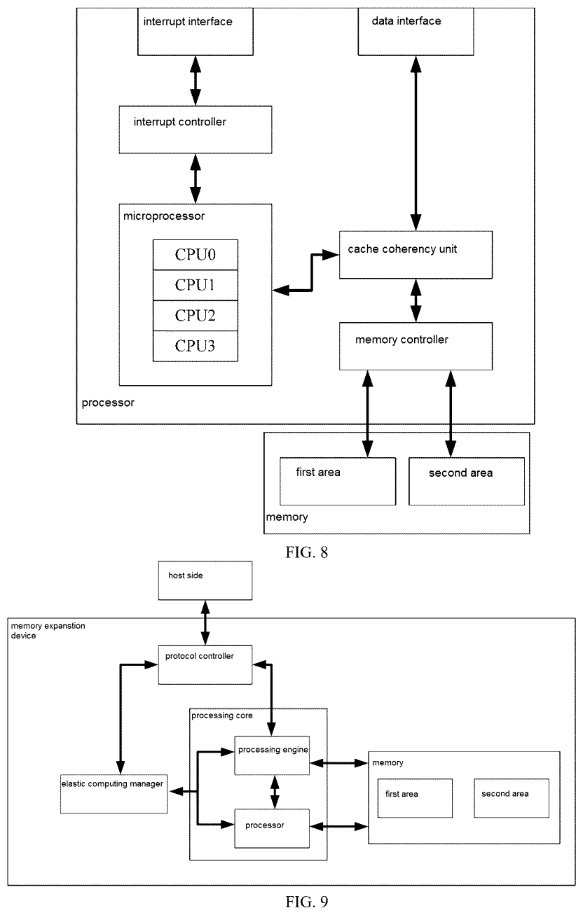

In one embodiment, as shown in FIGS. 8 and 9, the target data includes a write request data stream, the processor includes an interrupt controller and a microprocessor, the interrupt controller is connected to the elastic computing manager and the microprocessor respectively, and the elastic computing manager is connected to the protocol controller, wherein:
the elastic computing manager is further configured to send a first interrupt signal to the interrupt controller when the processor receives the target data, and is configured to trigger the protocol controller to send data processing completion information to the host side in response to receiving a second interrupt signal;
the interrupt controller is configured to trigger the microprocessor to perform offline processing in response to receiving the first interrupt signal, and is configured to send the second interrupt signal to the elastic computing manager when the microprocessor completes the data processing operation on the target data.

In this embodiment, the elastic computing manager is connected to the protocol controller through the instruction bus. When the data associated with the target data request enters (or all enters) the processor, the elastic computing manager can submit a trigger event to the processor (such as the interrupt controller of the processor) to trigger the processor to process the data associated with the target data request.

Illustratively, the microprocessor is sequentially connected to the IO transaction bus of the protocol controller through an interrupt controller, an interrupt interface and an elastic computing manager to submit an interrupt event to the host side through a message. The interrupt interface is configured to receive external interrupt signals (such as the first interrupt signal) and output external interrupt signals (such as the second interrupt signal). When data streams (such as all data streams to be written by the host side) enter the processor through the data interface of the processor, the elastic computing manager sends the first interrupt signal to the interrupt controller, and the microprocessor in the processor starts to perform the pre-configured computing flow (i.e., perform offline computing) on all written data streams. When all the calculation processes are finished, the interrupt controller in the processor sends the second interrupt signal to the elastic computing manager, so that the elastic computing manager informs the host side of the completion of data processing through the protocol controller.

It can be understood that the above-mentioned elastic computing manager is mainly responsible for processing the interrupt signal of the microprocessor and the conversion of IO sub-protocol messages in the transaction layer of the protocol controller, in addition to controlling the processing core to switch modes. For example, when the host side sets the interrupt register of the processing core to a valid value through the IO sub-protocol, the elastic computing manager submits a trigger event through the interrupt controller to trigger the microprocessor to perform offline processing. When the microprocessor finishes the calculation process, it modifies the corresponding register through the memory mapping bus, and then the elastic computing manager generates message signaled interrupts (MSI) or message signaled interrupts extended (MSI-X) messages and submits them to the host side through the IO sub-protocol of the transaction layer of the protocol controller to inform the host side that the processed data can be read.

In one embodiment, as shown in FIG. 9, the processing core includes a processor and a processing engine, the protocol controller is connected to the processing engine, the processing engine is connected to the processor, the elastic computing manager is connected to the processing engine and the processor respectively, and the processor is connected to the memory.

It can be understood that the embodiments of the present disclosure construct a heterogeneous processing core by using a processor and a processing engine, so that the processing core can adaptively support online processing and/or offline processing of data by mode switching of the processor and the processing engine, which can further enhance the flexibility and convenient development of the processing core.

The processing engine is located at the upstream of the entire processing core and is connected to the protocol controller and the processor respectively through the data bus. It performs online computing on the data stream it currently receives and may embed control status parameters in the data stream to be transmitted to the processor to switch the processor to bypass mode or working mode. The processor is at the downstream of the entire processing core and is connected to the processing engine and the memory respectively. Different from the processing engine in the upstream link, the multi-core processor, as the downstream engine, has a more elastic processing mode, which is mainly due to two reasons: one is that the processing object of the processor includes the whole memory area, not just the data stream read or written by the current host side; The other is the flexibility of programming mode, and the processor can realize offline calculation with the help of various excellent library functions in the operating system environment and the multithreading mechanism of multi-core processors.

As a possible implementation, as shown in FIG. 8, the processor includes a microprocessor (which may include one or more CPUs) and a cache coherency unit (CCU), and the CCU is respectively connected to the processing engine, the memory and the microprocessor, wherein:
the microprocessor is configured to offline process the target data received by the cache coherency unit according to a pre-configured calculation flow of the microprocessor when the processor is in the working mode, and not to offline process the target data received by the cache coherency unit when the processor is in the bypass mode;
the cache coherency unit is configured to submit the target data received by the cache coherency unit to the microprocessor for offline processing when the processor is in the working mode, and directly submit the target data received by the cache coherency unit to the memory or the processing engine when the processor is in the bypass mode.

It can be understood that the cache coherency unit can be configured to transmit the data stream received by itself, cache the memory data needed by the processor to perform data processing operations, and maintain the consistency of the cache. Wherein, the cache of microprocessor can be refreshed based on hardware or software to maintain the consistency between cache and memory.

In some embodiments, the microprocessor can be configured to start the cache sniffing function of CCU to refresh the cache of the microprocessor, so that it is not necessary to refresh the cache by software, thus improving the processing efficiency.

In some embodiments, as shown in FIG. 8, the processor further includes a memory controller, and the memory controller is respectively connected to the cache coherency unit and the memory, wherein:
the memory controller is configured to write data received by itself (such as write request data stream) into the memory, or read data from the memory according to the read request sent by the host side (or the data read request sent by the microprocessor, which is configured to obtain the data needed by the microprocessor to process the received read-write request stream), and submit the data read by itself to the cache coherency unit for transmitting or caching. Wherein, the CCU can refresh the cache of the microprocessor in the process of submitting the above data reading request to the memory controller, to maintain cache consistency, so that the microprocessor may use the latest memory data to perform data processing.

As a possible implementation, the microprocessor is also configured to turn on the cache sniffing function of the cache coherency unit when the processor is in the working mode, so that the cache coherency unit can refresh the cache of the processor;

[symbol]

The microprocessor is also configured to turn off the cache sniffing function of the cache coherency unit when the processor is in the bypass mode, so that the cache coherency unit does not refresh the cache of the processor.

In this embodiment, considering that the microprocessor needs to perform data processing operations according to the cached data when the processor is in the working mode, the microprocessor may control the CCU to turn on the cache sniffing function to refresh the cache in time when the CCU receives the data, to maintain cache consistency; When the processor is in bypass mode, because the microprocessor does not perform data processing operations, the microprocessor may control the CCU to turn off the cache sniffing function and not refresh the cache to reduce the delay.

In the second aspect, the embodiments of the present disclosure provide a data processing system, which includes a host side and a memory expansion device as in the first aspect, and the host side is connected to the memory expansion device.

In some embodiments, the system includes at least two memory expansion devices, and the system also includes switch devices, the host side is connected to the switch devices, and the switch devices are connected to the at least two memory expansion devices respectively.

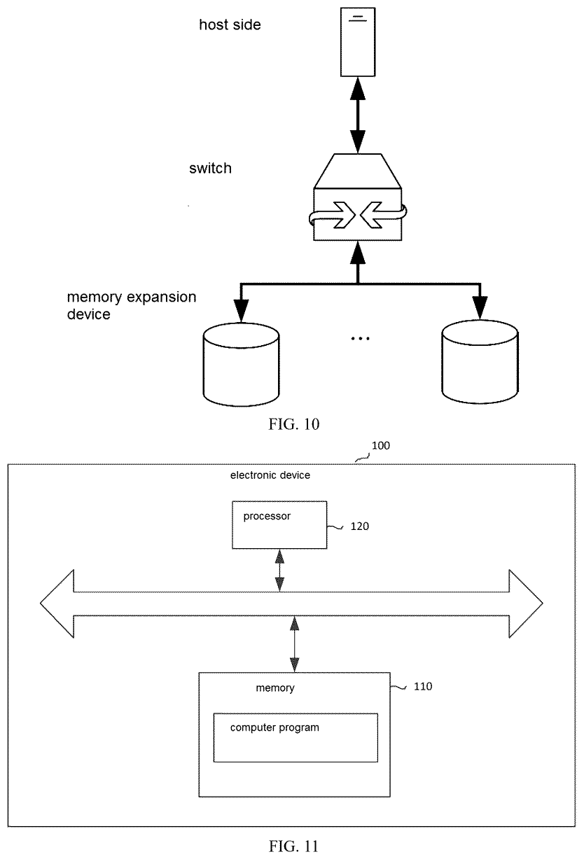

In this embodiment, as shown in FIG. 10, under the condition that the number of interfaces (such as CXL interfaces) on the host side is limited, a switch can be configured to connect a plurality of memory expansion devices as in the embodiments of the present disclosure, and each memory expansion device is connected to the CPU on the host side through the switch and CXL interface in turn, In this way, by offloading part of CPU operations to the memory expansion device, the total delay of CPU accessing the memory expansion devices through the switch can be reduced, thereby improving the efficiency of CPU in performing computing tasks.

It can be seen from the above technical solution that the processing core is configured between the protocol controller and the memory in the memory expansion device, and the processing core is controlled by the elastic computing manager to perform data processing operations required by different computing tasks through different data processing paths, thus implementing a general memory expansion device supporting programmable inline computing functions, which can meet the computing requirements of different computing tasks. Therefore, part of the operations of the host side may be offloaded to the memory expansion device, and the memory access and data processing operations related to the calculation tasks are carried out inside the memory expansion device, so that a large number of high-delay memory accesses between the host side and the memory expansion device involved in the execution process of the calculation tasks by the host side are replaced by low-delay accesses inside the memory expansion device, thereby reducing the total delay of the execution of the calculation tasks by the host side and improving the execution efficiency of the calculation tasks by the host side.

In a third aspect, an embodiment of the present disclosure provides a data processing method, which is applied to the memory expansion device as disclosed in the embodiments of the first aspect, and the method may include the following steps:
step S101: receiving, by the protocol controller, the target data request sent by the host side;
step S102: switching, by the elastic computing manager, the processing mode of the processing core according to the target data request;
step S103: performing, by the processing core, data processing operation on the target data associated with the target data request through the data processing path corresponding to the processing mode of the processing core, and submitting, by the processing core, the processed target data to the memory or transmitting the processed target data to the host side through the protocol controller;
wherein, the data processing paths at least comprise data processing paths corresponding to data processing operations performed on the target data in the online processing mode and/or the offline processing mode.

It can be seen from the above technical solution that the processing core is configured between the protocol controller and the memory in the memory expansion device, and the processing core is controlled by the elastic computing manager to perform data processing operations required by different computing tasks through different data processing paths, thus implementing a general memory expansion device supporting programmable inline computing functions, which can meet the computing requirements of different computing tasks. Therefore, part of the operations of the host side may be offloaded to the memory expansion device, and the memory access and data processing operations related to the calculation tasks are carried out inside the memory expansion device, so that a large number of high-delay memory accesses between the host side and the memory expansion device involved in the execution process of the calculation tasks by the host side are replaced by low-delay accesses inside the memory expansion device, thereby reducing the total delay of the execution of the calculation tasks by the host side and improving the execution efficiency of the calculation tasks by the host side.

As a possible implementation, the processing core includes a processing engine and a processor, and the elastic computing manager is respectively connected to the processing engine and the processor;
the elastic computing manager switches the processing modes of the processing core according to the target data request;
the elastic computing manager switches the processing modes of the processing engine and the processor according to the target data request.

The method further includes:
the processing engine selecting to perform data processing operation on the data passing through the processing engine in an online processing mode or not to perform data processing operation on the data passing through the processing engine according to the current processing mode of the processing engine;
the processor selecting to perform data processing operation on the data passing through the processor in an offline processing mode or not to perform data processing operation on the data passing through the processor according to the current processing mode of the processor.

As a possible implementation, wherein the processing core performs data processing operations on the target data associated with the target data request through the data processing path corresponding to the processing mode of the processing core, including:
under the condition that the processing engine is in a working mode and the processor is in a bypass mode, performing data processing operation on the data passing through the processing core in the online processing mode through a first data processing path;
under the condition that the processing engine is in a straight-through mode and the processor is in a working mode, performing data processing operation on the data passing through the processing core in an offline processing mode through a second data processing path;
under the condition that the processing engine is in the working mode and the processor is in the working mode, performing data processing operation on the data passing through the processing core in an online processing mode and an offline processing mode through a third data processing path;
under the condition that the processing engine is in the straight-through mode and the processor is in the bypass mode, not performing data processing operation on the data passing through the processing core through a fourth data processing path.

As a possible implementation, wherein the processing engine includes a write request data stream processing unit and a read request data stream processing unit;
the elastic computing manager switches the processing mode of the processing engine based on the target data request, including:
the elastic computing manager selecting at least one of the write request data stream processing unit and the read request data stream processing unit to switch to the working mode according to the target data request, so that the processing engine is in the working mode, or selecting to switch both the write request data stream processing unit and the read request data stream processing unit to the straight-through mode, so that the processing engine is in the straight-through mode.

As a possible implementation, wherein the target data includes at least one of a write request data stream and a read request data stream;
the processing engine selecting to perform data processing operations on the data passing through the processing engine in online processing mode, or selecting not to perform data processing operations on the data passing through the processing engine according to the processing mode of the processing engine, including:
the write request data stream processing unit performing data processing operation on the write request data stream in the first data processing path or the third data processing path in the online processing mode when the write request data stream processing unit is in the working mode, and not performing data processing operation on the write request data stream in the second data processing path or the fourth data processing path when the write request data stream processing unit is in the straight-through mode;
the read request data stream processing unit performing data processing operations on the read request data stream in the first data processing path or the third data processing path in the online processing mode when the read request data stream processing unit is in the working mode, and not performing data processing operations on the read request data stream in the second data processing path or the fourth data processing path when the read request data stream processing unit is in the straight-through mode.

As a possible implementation, wherein the write request data stream processing unit includes a plurality of downstream processing cores, and the read request data stream processing unit includes a plurality of upstream processing cores, when the write request data steam processing unit is in working mode, it performs data processing operations on the write request data flow in the first data processing path or the third data processing path in the online mode, including:
the plurality of downstream processing cores performing data processing operations on the write request data stream passing through the write request data stream processing unit in parallel under the condition that the write request data stream processing unit is in the working mode;
the plurality of upstream processing cores performing data processing operations on the read request data stream passing through the read request data stream processing unit in parallel when the read request data stream processing unit is in the working mode.

As a possible implementation, wherein the processor includes a microprocessor and a cache coherency unit, and the cache coherency unit is respectively connected to the processing engine, the memory and the microprocessor;
the processor selects to perform data processing operations on the processed data in offline processing mode, or selects not to perform data processing operations on the processed data according to the processing mode of the processor, including:
the microprocessor offline processing the target data received by the cache coherency unit according to a pre-configured calculation flow of the microprocessor when the processor is in the working mode, and not offline processing the target data received by the cache coherency unit when the processor is in the bypass mode;
and the method further including:
the cache coherency unit submitting the target data received by the cache coherency unit to the microprocessor for offline processing when the processor is in the working mode, and directly submitting the target data received by the cache coherency unit to the memory or the processing engine when the processor is in the bypass mode.

As a possible implementation, the method further includes:
the microprocessor turning on a cache sniffing function of the cache coherency unit when the processor is in the working mode, to make the cache coherency unit refresh the cache of the processor;
the microprocessor turning off the cache sniffing function of the cache coherency unit when the processor is in the bypass mode to make the cache coherency unit does not refresh the cache of the processor.

As a possible implementation, wherein the target data includes a write request data stream, and the processor further includes an interrupt controller, and the interrupt controller is respectively connected to the elastic computing manager and the microprocessor;
and the method further includes:
the elastic computing manager sending a first interrupt signal to the interrupt controller when the processor receives the target data, and triggering the protocol controller to send data processing completion information to the host side in response to receiving a second interrupt signal;
the interrupt controller triggering the microprocessor to perform offline processing in response to receiving the first interrupt signal, and sending the second interrupt signal to the elastic computing manager when the microprocessor completes the data processing operation on the target data.

As a possible implementation, the method further includes:
the processing engine switching the processing mode of the processing engine according to a first parameter in the target data received by the processing engine.

As a possible implementation, the method further includes:
the processing engine adding a second parameter to the target data received by the processing engine and send the target data to the processor;
the processor switching the processing mode of the processor according to the second parameter in the target data received by the processor.

As a possible implementation, wherein the processor is a multi-core processor, and the multi-core processor includes a hard core processor or a soft core processor.

As a possible implementation, wherein the memory includes a first area and a second area, wherein the first area is configured to store data not processed by the processing core, and the second area is configured to store data processed by the processing core.

As a possible implementation, wherein the processing core includes a processing engine configured to perform data processing operation on the target data in the online processing mode, wherein the target data includes the write request data stream, and the processing engine further includes a metadata interface, wherein the write request data stream processing units in the processing engine are respectively connected to the metadata interface and the second area, and the metadata interface is connected to the first area, and the method further includes:
the write request data stream processing unit directly submitting the write request data stream submitted by the host side through the protocol controller to the first area through the metadata interface, and performing data processing operation on the write request data stream and submit the processed write request data stream to the second area.

As a possible implementation, wherein the processing core includes a processing engine configured to perform data processing operation on the target data in the online processing mode, wherein the target data includes the read request data stream, and the processing engine further includes a metadata interface, wherein the read request data stream processing units in the processing engine are connected to the metadata interface and the second area respectively, and the metadata interface is connected to the first area, and the method further includes:
the elastic computing manager controlling the read request data stream processing unit to perform a first read operation when the target data request sent by the host side includes a first read request, receiving the read request data stream submitted by the first area through the metadata interface, and directly transmitting the received read request data stream to the host side through the protocol controller;
the elastic computing manager controlling the read request data stream processing unit to perform a second read operation when the target data request sent by the host side includes a second read request, performing data processing operation on the read request data stream submitted by the first area or the second area, and transmitting the processed read request data stream to the host side through the protocol controller, or transmit the read request data stream submitted by the second area to the host side through the protocol controller.

As a possible implementation, wherein the processing engine further includes a control status register, and the control status register is respectively connected to the read request data stream processing unit and the elastic computing manager, the method further includes:
the elastic computing manager controlling the read request data stream processing unit to execute the first read operation or the second read operation through the control status register.

As a possible implementation, wherein a processor is respectively connected to the first area and the second area, and the method further includes:
the processor performing data processing operation on the write request data stream submitted by the host side through the protocol controller in the offline processing mode, submitting the processed write request data to the second area, and performing data processing operation on the read request data stream submitted by the first area and/or the second area in the offline processing mode, and transmitting the processed read request data stream to the host side through the protocol controller.

The data processing method provided in the embodiments of the present disclosure can realize each process of the embodiments of the processing core side of the memory expansion device in the first aspect, and achieve the same technical effect. In order to avoid repetition, it will not be described here.

The embodiments of the present disclosure also provide an electronic device, and reference is made to FIG. 11, which is a schematic diagram of an electronic device proposed by the embodiment of the present disclosure. As shown in FIG. 11, the electronic device 100 includes a memory 110 and a processor 120. The memory 110 and the processor 120 are connected by bus communication, and a computer program is stored in the memory 110, which can be run on the processor 120, thereby realizing the steps in the data processing method disclosed in the embodiments of the present disclosure.

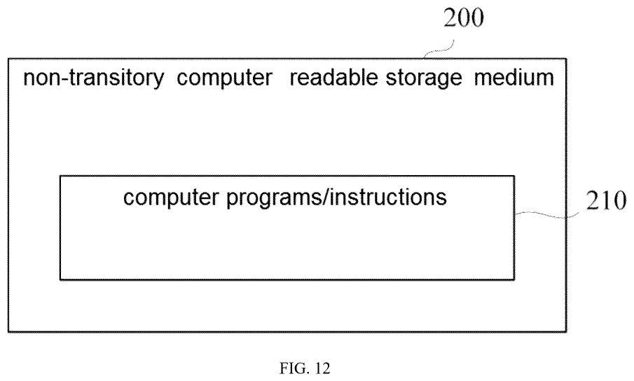

The embodiments of the present disclosure also provide a non-transitory computer readable storage medium, refer to FIG. 12, which is a schematic diagram of the non-transitory computer readable storage medium proposed by the embodiment of the present disclosure. As shown in FIG. 12, a non-transitory computer readable storage medium 200 stores a computer program/instruction 210, which, when executed by a processor, realizes the steps in the data processing method disclosed in the embodiments of the present disclosure.

The embodiments of the present disclosure also provide a computer program product, including computer programs/instructions, which, when executed by a processor, realize the steps in the data processing method disclosed in the embodiments of the present disclosure.

The processor includes the processing core and the elastic computing manager in the memory expansion device of the above embodiments, and the non-transitory readable storage medium includes non-transitory computer readable storage medium, such as computer Read-Only Memory (ROM), Random Access Memory (RAM), magnetic disk or optical disk.

It should be noted that in this paper, the terms “including”, “containing” or any other variation thereof are intended to cover non-exclusive inclusion, so that a process, method, article or device including a series of elements includes not only those elements, but also other elements not explicitly listed, or elements inherent to such process, method, article or device. Without more restrictions, an element defined by the phrase “including one” does not exclude the existence of other identical elements in the process, method, article or device including the element. In addition, it should be pointed out that the scope of the methods and devices in the embodiments of the present disclosure is not limited to performing functions in the order shown or discussed, but also can include performing functions in a substantially simultaneous manner or in the reverse order according to the functions involved. For example, the described methods can be performed in a different order from that described, and various steps can be added, omitted, or combined. In addition, features described with reference to some examples can be combined in other examples.

Through the description of the above embodiments, those skilled in the art can clearly understand that the methods of the above embodiments can be realized by means of software and necessary general hardware platform, and of course they can also be realized by hardware, but in many cases, the former is the better embodiment. Based on this understanding, the technical solution of the present disclosure can be embodied in the form of a computer software product, which is stored in a non-transitory readable storage medium (such as ROM/RAM, magnetic disk and optical disk) and includes several instructions to make a terminal execute the methods of various embodiments of the present disclosure.

The embodiments of the present disclosure have been described above with the attached drawings, but the present disclosure is not limited to the above specific embodiments, which are only schematic, not restrictive. Under the inspiration of the present disclosure, persons skilled in the art can make many forms without departing from the purpose of the present disclosure and the scope protected by the claims, which are all within the protection of the present disclosure.

1. A memory expansion device, wherein the memory expansion device comprises a processing core, a protocol controller, an elastic computing manager and a memory, wherein the protocol controller is configured to be connected to a host side, the processing core is connected to the protocol controller, the elastic computing manager and the memory respectively, and the protocol controller is connected to the elastic computing manager, wherein:
the protocol controller is configured to communicate with the host side and receive a target data request sent by the host side;
the elastic computing manager is configured to switch a processing mode of the processing core according to the target data request;
the processing core is configured to perform data processing operations on target data associated with the target data request by different data processing paths according to different current processing modes of the processing core, and submit the processed target data to a memory or transmit the processed target data to the host side by the protocol controller;
wherein, the different data processing paths at least comprise data processing paths corresponding to data processing operations performed on the target data in an online processing mode and/or an offline processing mode.

2. The device according to claim 1, wherein the processing core comprises a processing engine and a processor, and the elastic computing manager is respectively connected to the processing engine and the processor, wherein:
the elastic computing manager is configured to switch the processing modes of the processing engine and the processor according to the target data request;
the processing engine is configured to select to perform data processing operation on the data passing through the processing engine in an online processing mode or not to perform data processing operation on the data passing through the processing engine according to the current processing mode of the processing engine;
the processor is configured to select to perform data processing operation on the data passing through the processor in an offline processing mode or not to perform data processing operation on the data passing through the processor according to the current processing mode of the processor.

3. The device according to claim 2, wherein the processing core is further configured to perform at least one of the following:
under the condition that the processing engine is in a working mode and the processor is in a bypass mode, performing data processing operation on the data passing through the processing core in the online processing mode through a first data processing path;
under the condition that the processing engine is in a straight-through mode and the processor is in a working mode, performing data processing operation on the data passing through the processing core in an offline processing mode through a second data processing path;
under the condition that the processing engine is in the working mode and the processor is in the working mode, performing data processing operation on the data passing through the processing core in an online processing mode and an offline processing mode through a third data processing path;
under the condition that the processing engine is in the straight-through mode and the processor is in the bypass mode, not performing data processing operation on the data passing through the processing core through a fourth data processing path.

4. The device according to claim 3, wherein the processing engine comprises a write request data stream processing unit and a read request data stream processing unit, wherein:
the elastic computing manager is configured to select at least one of the write request data stream processing unit and the read request data stream processing unit to switch to the working mode according to the target data request, so that the processing engine is in the working mode, or select to switch both the write request data stream processing unit and the read request data stream processing unit to the straight-through mode, so that the processing engine is in the straight-through mode.

5. The device according to claim 4, wherein the target data comprises at least one of a write request data stream and a read request data stream, wherein:
the write request data stream processing unit is configured to perform data processing operation on the write request data stream in the first data processing path or the third data processing path in the online processing mode when the write request data stream processing unit is in the working mode, and not to perform data processing operation on the write request data stream in the second data processing path or the fourth data processing path when the write request data stream processing unit is in the straight-through mode;
the read request data stream processing unit is configured to perform data processing operations on the read request data stream in the first data processing path or the third data processing path in the online processing mode when the read request data stream processing unit is in the working mode, and not to perform data processing operations on the read request data stream in the second data processing path or the fourth data processing path when the read request data stream processing unit is in the straight-through mode.

6. The device according to claim 5, wherein the write request data stream processing unit comprises a plurality of downstream processing cores, and/or the read request data stream processing unit comprises a plurality of upstream processing cores, wherein:
the plurality of downstream processing cores are configured to perform data processing operations on the write request data stream passing through the write request data stream processing unit in parallel under the condition that the write request data stream processing unit is in the working mode;
the plurality of upstream processing cores are configured to perform data processing operations on the read request data stream passing through the read request data stream processing unit in parallel when the read request data stream processing unit is in the working mode.

7. The device according to claim 3, wherein the processor comprises a microprocessor and a cache coherency unit, and the cache coherency unit is respectively connected to the processing engine, the memory and the microprocessor, wherein:
the microprocessor is configured to offline process the target data received by the cache coherency unit according to a pre-configured calculation flow of the microprocessor when the processor is in the working mode, and not to offline process the target data received by the cache coherency unit when the processor is in the bypass mode;
the cache coherency unit is configured to submit the target data received by the cache coherency unit to the microprocessor for offline processing when the processor is in the working mode, and directly submit the target data received by the cache coherency unit to the memory or the processing engine when the processor is in the bypass mode.

8. The device according to claim 7, wherein the microprocessor is further configured to turn on a cache sniffing function of the cache coherency unit when the processor is in the working mode, to make the cache coherency unit refresh the cache of the processor;
the microprocessor is further configured to turn off the cache sniffing function of the cache coherency unit when the processor is in the bypass mode to make the cache coherency unit does not refresh the cache of the processor.

9. The device according to claim 7, wherein the target data comprises a write request data stream, and the processor further comprises an interrupt controller, and the interrupt controller is respectively connected to the elastic computing manager and the microprocessor, wherein:
the elastic computing manager is further configured to send a first interrupt signal to the interrupt controller when the processor receives the target data, and is configured to trigger the protocol controller to send data processing completion information to the host side in response to receiving a second interrupt signal;
the interrupt controller is configured to trigger the microprocessor to perform offline processing in response to receiving the first interrupt signal, and is configured to send the second interrupt signal to the elastic computing manager when the microprocessor completes the data processing operation on the target data.

10. The device according to claim 2, wherein the processing engine is further configured to switch the processing mode of the processing engine according to a first parameter in the target data received by the processing engine.

11. The device according to claim 10, wherein the processing engine is further configured to add a second parameter to the target data received by the processing engine and send the target data to the processor;
the processor is further configured to switch the processing mode of the processor according to the second parameter in the target data received by the processor.

12. The device according to claim 2, wherein the processor is a multi-core processor, and the multi-core processor comprises a hard core processor or a soft core processor.

13. The device according to claim 1, wherein the memory comprises a first area and a second area, wherein the first area is configured to store data not processed by the processing core, and the second area is configured to store data processed by the processing core.

14. The device according to claim 13, wherein the processing core comprises a processing engine configured to perform data processing operation on the target data in the online processing mode, wherein the target data comprises the write request data stream, and the processing engine further comprises a metadata interface, wherein the write request data stream processing units in the processing engine are respectively connected to the metadata interface and the second area, and the metadata interface is connected to the first area, wherein:
the write request data stream processing unit is further configured to directly submit the write request data stream submitted by the host side through the protocol controller to the first area through the metadata interface, and perform data processing operation on the write request data stream and submit the processed write request data stream to the second area.

15. The device according to claim 13, wherein the processing core comprises a processing engine configured to perform data processing operation on the target data in the online processing mode, wherein the target data comprises the read request data stream, and the processing engine further comprises a metadata interface, wherein the read request data stream processing units in the processing engine are connected to the metadata interface and the second area respectively, and the metadata interface is connected to the first area, wherein:
the elastic computing manager is further configured to control the read request data stream processing unit to perform a first read operation when the target data request sent by the host side comprises a first read request, receive the read request data stream submitted by the first area through the metadata interface, and directly transmit the received read request data stream to the host side through the protocol controller;
the elastic computing manager is further configured to control the read request data stream processing unit to perform a second read operation when the target data request sent by the host side comprises a second read request, perform data processing operation on the read request data stream submitted by the first area or the second area, and transmit the processed read request data stream to the host side through the protocol controller, or transmit the read request data stream submitted by the second area to the host side through the protocol controller.

16. The device according to claim 15, wherein the processing engine further comprises a control status register, and the control status register is respectively connected to the read request data stream processing unit and the elastic computing manager, wherein:
the elastic computing manager is further configured to control the read request data stream processing unit to execute the first read operation or the second read operation through the control status register.

17. The device according to claim 13, wherein a processor is respectively connected to the first area and the second area, wherein:
the processor is further configured to perform data processing operation on the write request data stream submitted by the host side through the protocol controller in the offline processing mode, submit the processed write request data to the second area, and perform data processing operation on the read request data stream submitted by the first area and/or the second area in the offline processing mode, and transmit the processed read request data stream to the host side through the protocol controller.

18. A data processing system, comprising a host side and a memory expansion device according to claim 1, wherein the host side is connected to the memory expansion device.

19. The system according to claim 18, wherein the system comprises at least two memory expansion devices, and the system further comprises a switch device, wherein the host side is connected to the switch device, and the switch device is connected to at least two memory expansion devices respectively.

20. A data processing method, which is applied to the memory expansion device according to claim 1, comprising:
receiving, by the protocol controller, the target data request sent by the host side;
switching, by the elastic computing manager, the processing mode of the processing core according to the target data request;
performing, by the processing core, data processing operation on the target data associated with the target data request through the data processing path corresponding to the processing mode of the processing core, and submitting, by the processing core, the processed target data to the memory or transmitting the processed target data to the host side through the protocol controller;
wherein, the data processing paths at least comprise data processing paths corresponding to data processing operations performed on the target data in the online processing mode and/or the offline processing mode.
